(19) United States
(12) Patent Application Publication
(10) Pub. No.: US 2013/0114183 A1
(43) Pub. Date: May 9, 2013

(54) ELECTRODE ACTIVE MATERIAL COMPOSITION, METHOD FOR PREPARING THE SAME, AND ELECTROCHEMICAL CAPACITOR USING THE SAME

(71) Applicant: Samsung Electro-Mechanics Co., Ltd., Suwon (KR)

(72) Inventors: Sang Kyun LEE, Suwon (KR); Ji Sung CHO, Suwon (KR); Bae Kyun KIM, Seongnam (KR)

(73) Assignee: SAMSUNG ELECTRO-MECHANICS CO., LTD., Suwon (KR)

(21) Appl. No.: 13/666,355

(22) Filed: Nov. 1, 2012

(30) Foreign Application Priority Data
Nov. 4, 2011 (KR) 10-2011-0114467

(51) Int. Cl. H01B 1/00; H01G 9/042; B82Y 99/00

(52) U.S. Cl. 361/523; 428/402; 252/500; 977/932

(57) ABSTRACT

Disclosed herein are an electrode active material composition, a method for preparing the same, and an electrochemical capacitor using the same, the electrode active material composition including: an electrode active material; and a conductive material agglomerate having a size of 1/7 to 1/10 times the average particle size of the electrode active material, the conductive material agglomerate containing two or more kinds of conductive materials agglomerated therein, thereby providing electron moving paths through which electrons can move well and increasing packing density of an electrode active material layer, resulting in increasing capacity.

### CROSS REFERENCE(S) TO RELATED APPLICATIONS

This application claims the benefit under 35 U.S.C. Section 119 of Korean Patent Application Serial No. 10-2011-0114467, entitled “Electrode Active Material Composition, Method for Preparing the Same, and Electrochemical Capacitor Using the Same” filed on Nov. 4, 2011, which is hereby incorporated by reference in its entirety into this application.

### BACKGROUND OF THE INVENTION

1. Technical Field

The present invention relates to an electrode active material composition, a method for preparing the same, and an electrochemical capacitor using the same.

2. Description of the Related Art

In recent, an electric double layer capacitor (EDLC) has been successfully developed in relation to environmental problems because it has excellent input and output characteristics and high cycle reliability, as compared with a secondary battery, such as a lithium ion secondary battery. For example, the electric double layer capacitor is promising as a power-storage device, which stores main power and subsidiary power of electric vehicles or renewable energy such as solar light, wind power, or the like.

In addition, the electric double layer capacitor is expected to be also utilized as a device capable of outputting large current for a short time in an uninterruptible power supply which is increasingly demanded by information technology (IT).

This electric double layer capacitor has a structure where a pair of or a plurality of polarizable electrodes (positive electrode negative electrode) face each other with a separator therebetween, which is then immersed in an electrolytic liquid. Here, charges are stored on an electric double layer formed at an interface between the polarizable electrode and the electrolytic liquid.

FIG. 1 shows an operating principle and a basic structure of an electric double layer capacitor. Referring to this, current collectors 10, electrodes 20, an electrolytic liquid 30, and a separator 40 are disposed from both sides.

The electrode 20 consists of an active material made of a carbon material having a large effective specific surface area, such as an activated carbon powder, an activated carbon fiber, or the like, a conductive agent for imparting conductivity, and a binder for providing a binding force between respective components. In addition, the electrodes 20 include a cathode 21 and an anode 22 with a separator 40 therebetween.

In addition, as the electrolytic liquid 30, aqueous electrolytic liquid and non-aqueous (organic) electrolytic liquid are used.

The separator 40 is made by using polypropylene, Teflon, or the like, and serves to prevent a short circuit due to contact between the cathode 21 and the anode 22.

When voltage is applied to the EDLC at the time of charging, electrolytic ions 31a and 31b dissociated from surfaces of the cathode 21 and anode 22 are physically absorbed on the counter electrodes to store electricity. At the time of discharging, the ions of the cathode 21 and the anode 22 are desorbed from the electrodes, resulting in a neutralized state.

In general, an active material used as a main material of the electrochemical capacitor is advantageous in generation of electrons on an interface by using a wide specific surface area thereof. But, since the active material has relatively low conductivity, a nanometer-sized conductive material is generally added so as to implement required characteristics. However, a desired low resistance can not be realized by general processes even though only the added amount of the conductive material is increased. The reason is that the active material and the conductive material are not uniformly combined due to dispersive and structural characteristics of fine-grain conductive agent.

In cases of general electrochemical capacitors, expression of electrons due to absorbing and desorbing reactions of electrolytic ions on a surface of the active material leads to implementation of capacity. FIG. 2 is a general view of an electrode (20) of an electrochemical capacitor. The electrode 20 is formed by coating an electrode active material layer on a current collector 10. The electrode active material layer is constituted of an active material 51 made of a carbon material having a large effective specific surface area, a conductive material 52 for imparting conductivity, and a binder 53 for binding the respective components. Electrons expressed by adsorption and desorption of ions flow through the conductive material 52, as shown in FIG. 2. It is general that electrons flow along the path having the smallest resistance. Reasonably, the electrons 60 flow along the conductive material 52 (in an arrow direction) since the conductive material 52 has lower specific resistivity by two orders than the active material 51.

In general, the active material 51, which is a main influence on the expression of electrons, has a size of several micrometers, as shown in FIG. 3. The conductive material 52, which corresponds to a moving path of electrons, has a size of several tens of nanometers, as shown in FIG. 4.

This difference in particle size between the active material and the conductive material makes it difficult to anticipate that the active material and the conductive material are uniformly mixed within the electrode.

Actually, agglomeration of the conductive material may occur, or segregation of particles may occur due to the difference in particle size between the active material and the conductive material, as shown in FIG. 5. Therefore, pores may occur among particles, and thus, resistance of a product becomes deteriorated, resulting in poor reliability of the electrochemical capacitor.

### SUMMARY OF THE INVENTION

An object of the present invention is to provide an active material composition of an electrochemical capacitor having excellent dispersibility, thereby solving several problems that occur due to rough dispersion caused by a difference in particle size between an active material and a conductive material in the electrochemical capacitor of the related art.

Another object of the present invention is to provide a method for preparing an active material composition of an electrochemical capacitor.

Still another object of the present invention is to provide an electrochemical capacitor including the active material composition.

According to one exemplary embodiment of the present invention, there is provided an electrode active material composition, including: an electrode active material; and a conductive material agglomerate having a size of 1/7 to 1/10 times the average particle size of the electrode active material, the conductive material agglomerate containing two or more kinds of conductive materials agglomerated therein.

The conductive material agglomerate may contain two or more kinds of conductive materials having different particle sizes.

The conductive material agglomerate may contain a first conductive material having a particle size of 10 to 99 nm and a second conducive material having a particle size of 100 to 10 μm.

The conductive material may be at least one conductive carbon selected from the group consisting of acetylene black, carbon black, and ketjen black.

The electrode active material may be a carbon material having a particle size of 5 to 30 μm.

The electrode active material may be at least one carbon material selected from the group consisting of activated carbon, carbon nanotube (CNT), graphite, carbon aero gel, polyacrylonitrile (PAN), carbon nanofibers (CNF), activated carbon nanofibers (ACNF), vapor-grown carbon fiber (VGCF), and graphene.

The electrode active material may be an activated carbon having a specific surface area of 1,500 to 3,000 m²/g.

Here, a weight ratio of the electrode active material to the conductive agglomerate may be 8.5:0.5 to 1:0.5 to 1.

According to another exemplary embodiment of the present invention, there is provided a method for preparing an electrode active material composition, including: agglomerating two or more kinds of conductive materials to prepare a conductive material agglomerate; and mixing and dispersing the conductive agglomerate and an electrode active material.

According to still another exemplary embodiment of the present invention, there is provided an electrochemical capacitor using the electrode active material composition as described above.

The electrode active material may be used for any one or both of a cathode and an anode.

### BRIEF DESCRIPTION OF THE DRAWINGS

FIG. 1 shows a basic structure and an operating principle of an electric double layer capacitor;

FIG. 2 is a general view of an electrode of an electrochemical capacitor;

FIG. 3 shows scanning electron microscope pictures of sizes and shapes of particles of an active material;

FIG. 4 shows scanning electron microscope pictures of sizes and shapes of particles of a conductive material;

FIG. 5 shows scanning electron microscope pictures of types of pores present in the electrode of the electrochemical capacitor and magnification of the pores;

FIGS. 6 and 7 show scanning electron microscope pictures of a first conductive material and a second conductive material constituting a conductive material agglomerate according to an exemplary embodiment of the invention;

FIG. 8 shows a scanning electron microscope picture of an electrode including a single conductive material according to Comparative Example 1; and

FIG. 9 shows a scanning electron microscope picture of an electrode including a conductive material agglomerate according to Example 1.

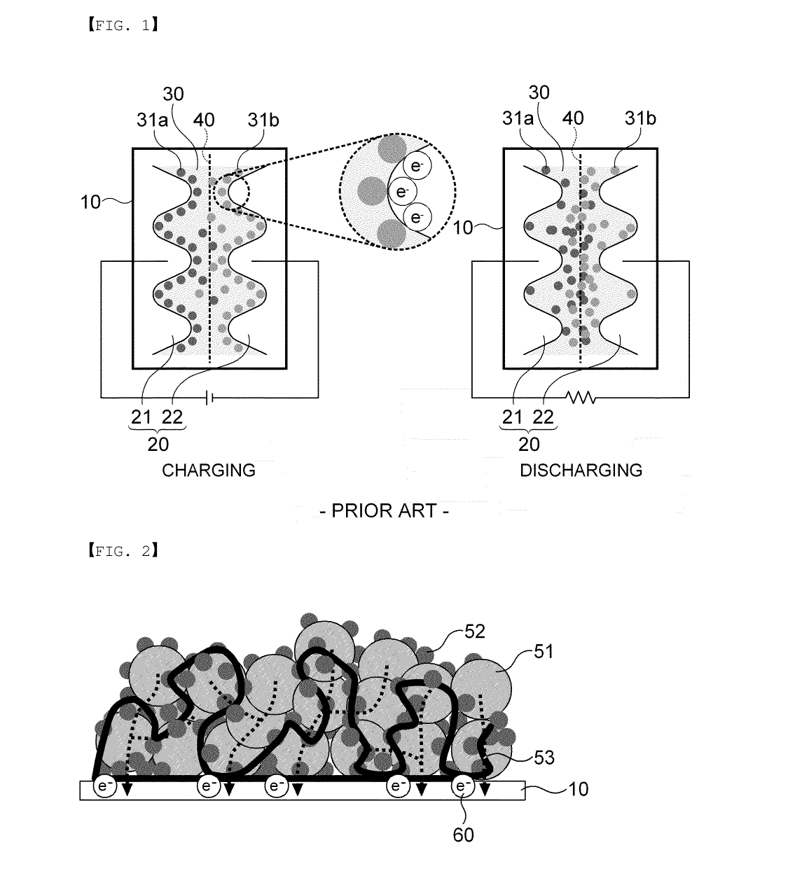

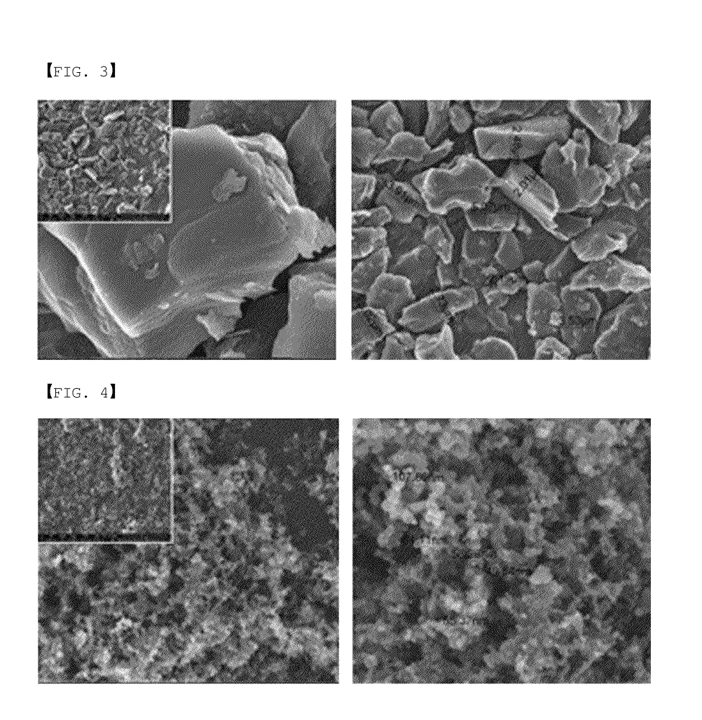

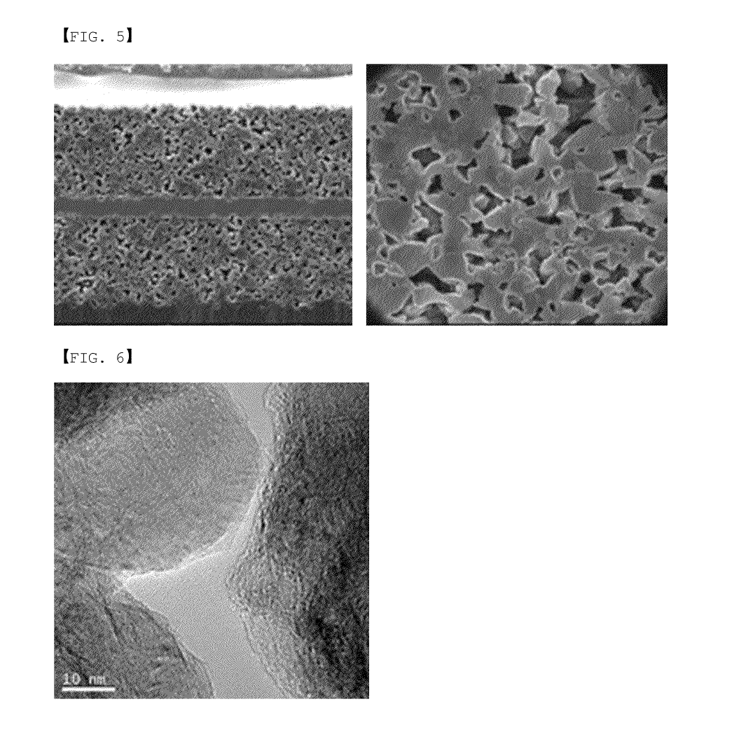

### DESCRIPTION OF THE PREFERRED EMBODIMENTS

Hereinafter, the present invention will be described in more detail.

Terms used in the present specification are for explaining the embodiments rather than limiting the present invention. Unless explicitly described to the contrary, a singular form includes a plural form in the present specification. Also, used herein, the word “comprise” and/or “comprising” will be understood to imply the inclusion of stated constituents, steps, operations and/or elements but not the exclusion of any other constituents, steps, operations and/or elements.

According to the present invention, the electrode active material composition includes a conductive material agglomerate prepared by using two or more kinds of conductive materials having different particle sizes, in order to solve the problem of separation of particles occurring due to a difference in particle size between the electrode active material and the conductive material.

Specifically, the electrode active material composition according to the present invention includes a conductive material agglomerate having a size of 1/7 to 1/10 times the average particle size of an electrode active material. Here the conductive material agglomerate contains two or more kinds of conductive materials agglomerated therein, in order to achieving the optimum electrode packing density.

If the size of the conductive material agglomerate according to the present invention is out of the range of 1/7 to 1/10 times the size of the average particle size of the electrode active material, the conductive material does not fill in particles of the active material appropriately, which causes the electrode packing density to be deteriorated.

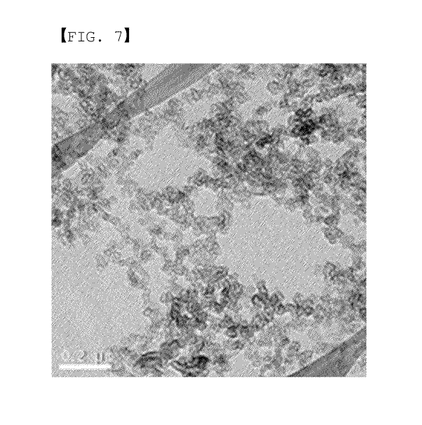

The conductive material included in the conductive material agglomerate according to the present invention may include two or more kinds of conductive materials having different sizes. Specifically, as shown in FIG. 6, the conductive material may include a first conductive material having a particle size of several tens of nm, preferably 10 to 99 nm, and a second conductive material having a particle size of several hundreds of nm to several μm, preferably 100 nm to 10 μm.

The particle size of the first conductive material is relatively small. If the particle size thereof is below 10 nm, the first conductive material is difficult to disperse. If the particle size of the first conductive material is above 99 nm, improvement of conductivity is limited.

Also, the particle size of the second conductive material is relatively large. If the particle size thereof is below 100 nm, the second conductive material is difficult to disperse well together with the first conductive material. If the particle size thereof is above 10 μm, conductivity may be deteriorated.

As the conductive material according to the present invention, at least one conductive carbon selected from the group consisting of acetylene black, carbon black, and ketjen black may be preferably used.

The conductive agglomerate according to the present invention may be prepared by dispersing well two or more kinds of conductive materials having different particle sizes in a water-based solvent or an organic solvent, and then evaporating a solvent thereof using spray drying or the like. In the expression that the conductive agglomerate has a size 1/7 to 1/10 times the particle size of the electrode active material, the size means a size of a pure conductive material agglomerate after evaporating the solvent.

The size of the conductive material agglomerate may be varied depending on a concentration in the solvent, and a temperature for spray drying, and a spray drying rate, and they may be appropriately controlled so as to have the above size.

Meanwhile, as the electrode active material included in the electrode active material of the present invention, a carbon material having a particle size of 5 to 30 μm may be used. Specific examples of the carbon material may include at least one selected from the group consisting of activated carbon, carbon nanotube (CNT), graphite, carbon aero gel, polyacrylonitrile (PAN), carbon nanofibers (CNF), activated carbon nanofibers (ACNF), vapor-grown carbon fiber (VGCF), and graphene, but not limited thereto.

According to one embodiment of the present invention, an activated carbon having a specific surface area of 1,500 to 3,000 m²/g, among the electrode active materials, may be preferably used.

The electrode active material composition according to the present invention may include the electrode active material and the conductive agglomerate at a weight ratio of 8.5:0.5 to 1:0.5-1.

Also, the electrode active material composition according to the present invention may, of course, include a binder resin and a solvent, which are normally included in an electrode active material composition.

Example of the binder may include at least one selected from fluorine-based resin such as polytetrafluoroethylene (PTFE), polyvinylidenefluoride (PVdF) and the like; thermoplastic resin such as polyimide, polyamideimide, polyethylene (PE), polypropylene (PP), and the like; cellulose-based resin such as carboxymethylcellulose (CMC) and the like; rubber-based resin such as styrene-butadiene rubber (SBR) and the like; and a mixture thereof, but are not limited thereto. Any binder resin that can be used in normal electrochemical capacitors may be used.

Further, the present invention is characterized by providing a method for preparing the electrode active material composition. First, the method of the present invention is characterized by aggregating two or more kinds of conductive materials to prepare a conductive material agglomerate; and mixing and dispersing the conductive material agglomerate and an electrode active material.

In order to prepare the conductive material agglomerate according to the present invention, two or more kinds of conductive materials having different particle sizes are dispersed and stabilized by using a mechanical stirrer for applying a high shear stress, and thus, a conductive material agglomerate having a size 1/7 to 1/10 times the average particle size of the electrode active material is prepared. The agglomerate may be prepared by respectively dispersing a slurry of the first conductive material and a slurry of the second conductive material using a planetary disperse mixer (PD mixer) or the like, and then mixing them, followed by spray dry.

The conductive material included in the conductive material agglomerate may preferably include a first conductive having a particle size of 10 to 99 nm and a second conductive material having a particle size of 100 nm to 10 μm.

In order to prepare the conductive agglomerate of the above size, the first conductive material and the second conductive material may be preferably mixed at a weight ratio of 10 to 90%.

When the conductive material agglomerate is prepared, the two or more kinds of conductive materials having different particle sizes may form a conductive material agglomerate or may be maintained in each of the conductive materials. Therefore, the conductive material which is included in the electrode active material composition so as to contribute to improve conductivity may be substantially the three, that is, the conductive material agglomerate, the first conductive material, and the second conductive material. Since sizes of these are different from one another, they are effectively positioned in empty spaces of the electrode active material, so as to provide electron moving paths through which electrons can move well and increase packing density of an electrode active material layer, resulting in increasing capacity.

Then, the conductive material agglomerate and the electrode active material are mixed and dispersed to prepare an electrode active material composition, and here, a solvent and a binder resin may be added thereto when the conductive material agglomerate is mixed with the electrode active material.

Further, the present invention may provide an electrochemical capacitor using the electrode active material composition. The electrode active material composition may be used for any one or both of the cathode and the anode.

In other words, the cathode in which the electrode active material composition prepared as above is coated on a cathode current collector and the anode in which the electrode active material composition prepared as above is coated on an anode current collector are insulated from each other by a separator, and this resulting structure is impregnated with an electrolytic liquid, following by sealing, thereby manufacturing a final electrochemical capacitor.

In addition, a mixture of the electrode active material, the conductive material, and the solvent is molded in a sheet shape by using a binder resin, or a molded sheet extruded through an extrusion manner may be attached to a current collector by using a conductive adhesive.

Any material that can be used in conventional electric double-layer capacitors or lithium ion batteries may be used for a cathode current collector. Examples of the material may be at least one selected from a group consisting of aluminum, stainless, titanium, tantalum, and niobium, and among them, aluminum is preferable.

Preferably, the cathode current collector may have a thickness of about 10 to 300 μm. An example of the current collector may include a metal foil, an etched metal foil, or those having holes penetrating through front and rear surfaces thereof, such as an expanded metal, a punching metal, a net, foam, or the like.

In addition, any material that can be used in conventional electric double-layer capacitors or lithium ion batteries may be used for an anode current collector. Examples of the material may be stainless, copper, nickel, or an alloy thereof, and among them, copper is preferable. Preferably, the anode current collector may have a thickness of about 10 to 300 μm. An example of the current collector may include a metal foil, an etched metal foil, or those having holes penetrating through front and rear surfaces thereof, such as an expanded metal, a punching metal, a net, foam, or the like.

For the separator according to the present invention, any material that can be used in conventional electric double-layer capacitors or lithium ion batteries may be used. A microporous film prepared from at least one polymer selected from the group consisting of polyethylene (PE), polypropylene (PP), polyvinylidene fluoride (PVDF), polyvinylidene chloride, polyacrylonitrile (PAN), polyacrylamide (PAAm), polytetrafluoroethylene (PTFE), poly-sulfone, polyethersulfone (PES), polycarbonate (PC), polyamide (PA), polyimide (PI), polyethylene oxide (PEO), polypropylene oxide (PPO), cellulose-based polymers, and polyacryl-based polymers may be used as the separator. In addition, a multilayer film in which the porous films are polymerized may be used, and among them, cellulose-based polymers may be preferably used.

The separator has a thickness of preferably 15 to 35 μm, but is not limited thereto.

As the electrolytic liquid of the present invention, an organic electrolytic liquid containing non-lithium salt such spyro-based salt, TEABF4, TEMABF4 or the like, or containing lithium salt such as LiPF₆, LiBF₄, LiCLO₄, LiN(CF₃SO₂)₂, CF₃SO₃Li, LiC(SO₂CF₃)₃, LiAsF₆ or LiSbF₆, or a mixture thereof may be used. Examples of the solvent may include at least one selected from the group consisting of acrylonitrile-based solvents, ethylene carbonate, propylene carbonate, dimethyl carbonate, ethylmethyl carbonate, sulfolane, and dimethoxyethane, but are not limited thereto. An electrolytic liquid obtained by combination of solutes and solvents has a high withstand voltage and high electric conductivity. A concentration of electrolyte in the electrolytic liquid is preferably 0.1 to 2.5 mol/L, and more preferably 0.5 to 2 mol/L.

As a case (exterior material) of the electrochemical capacitor of the present invention, a laminate film containing aluminum conventionally used in a secondary battery and an electric double layer capacitor may be used, but the case of the present invention is not particularly limited thereto.

Hereinafter, examples of the present invention will be described in detail. The following examples merely illustrate the present invention, but the scope of the present invention should not be construed to be limited by these examples. Further, the following examples are illustrated by using specific compounds, but it is apparent to those skilled in the art that equivalents thereof are used to obtain equal or similar levels of effects.

### EXAMPLE 1

50 g of Super-P with a particles size of 50 nm, as a first conductive material, and 250 g of ketjen black with a particle size of 2 to 3 μm, as a second conductive material, were dispersed and stabilized in an aqueous solution by using a mechanical stirrer. Next, the dispersed liquid was spry-dried within a heating chamber, thereby producing a conductive material agglomerate having a size of 1 to 1.5 μm.

20 g of the produced conductive material agglomerate, 200 g of 10 μm-sized activated carbon (specific surface area: 2000 m²/g), and 3.5 g of CMC, 12.0 g of SBR, and 5.5 g of PTFE, which are binder resins, were mixed and stirred in 225 g of water, to prepare an electrode active material slurry.

The electrode active material slurry was coated on an etched aluminum foil with a thickness of 20 μm by using a comma coater, followed by temporary drying, and then the resulting material was cut into 50 mm×100 mm electrodes. A cross-sectional thickness of the electrode is 60 μm. The electrodes were dried under vacuum conditions at 120° C. for 48 hours, before cell assembling.

A separator (TF4035 from NKK, cellulose-based separator) was inserted between the thus produced electrodes (cathode, anode), and then the resulting structure was impregnated with an electrolytic liquid (within a acrylonitrile-based solvent, spyro-based salt concentration: 1.3 mole/L), which was then put and sealed in a laminated film case. The thus completed cell was left intact for one day before experimental measurement.

### COMPARATIVE EXAMPLE 1

An electrochemical capacitor was manufactured by the same procedure as Example 1 except that 85 g of activated carbon (specific surface area: 2550 m²/g), 18 g of Super-P, and 3.5 g of CMC, 12.0 g of SBR, and 5.5 g of PTFE, which are binder resins, were mixed and stirred in 225 g of water to prepare an activated material slurry.

### EXPERIMENTAL EXAMPLE 1

### Determination of Shape of Electrode of Electrochemical Capacitor Cell

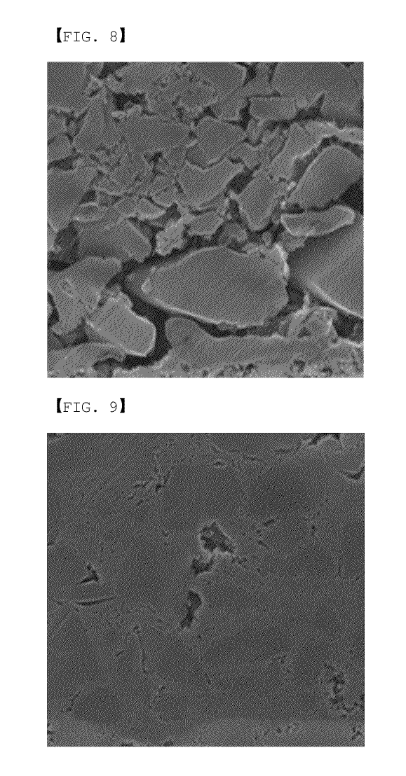

Electrodes of the electrochemical capacitor cells manufactured according to Comparative Example 1 and Example 1 were scanned by using a scanning electron microscopy, and the results were shown in FIGS. 8 and 9.

It can be seen from FIG. 8 that, in a case of Example 1 using a single conductive material, a plurality of empty spaces are present among respective constituent components within the electrode active material composition. In other words, it can be confirmed that a difference in particle size between the electrode active material and the conductive material failed to induce effective packing.

Whereas, it can be seen from FIG. 9 that, in a case of using a conductive material agglomerate having a size 1/7 to 1/10 times the particle size of the electrode active material, obtained from two kinds of conductive materials having different particle sizes, like the present invention, packing density of the active material composition was very high.

### EXPERIMENTAL EXAMPLE 2

### Measurement of Capacity of Electrochemical Capacitor Cell

While there were conducted constant-current charge to 2.8V at a predetermined level of current and constant current-current discharge to 2.0V at the same level of current as at the time of charging, discharging capacity in the 5th cycle was measured and DC IR was measured by a DC voltage drop at the time of discharging.

When the corresponding technology was applied, 1000 F of electrochemical capacitor cell was confirmed to embody a product of about 0.1 mW.

As set forth above, according to the present invention, the electrode active material includes a conductive material agglomerate having a specific size as compared with a particle size of an electrode active material by using two or more kinds of conductive materials having different sizes, and thus, the conductive material agglomerates are effectively positioned in empty spaces of the electrode active material, so as to provide electron moving paths through which electrons can move well and increase packing density of an electrode active material layer, resulting in increasing capacity.

Therefore, a large-capacity electrochemical capacitor having excellent reliability on rapid charge and discharge cycles as well as a high withstand voltage, high energy density, and high input and output characteristics can be manufactured.

While the present invention has been shown and described in connection with the embodiments, it will be apparent to those skilled in the art that modifications and variations can be made without departing from the spirit and scope of the invention as defined by the appended claims.

What is claimed is:

1. An electrode active material composition, comprising:
an electrode active material; and
a conductive material agglomerate having a size of 1/7 to 1/10 times the average particle size of the electrode active material, the conductive material agglomerate containing two or more kinds of conductive materials agglomerated therein.

2. The electrode active material composition according to claim 1, wherein the conductive material agglomerate contains two or more kinds of conductive materials having different particle sizes.

3. The electrode active material composition according to claim 1, wherein the conductive material agglomerate contains a first conductive material having a particle size of 10 to 99 nm and a second conducive material having a particle size of 100 to 10 μm.

4. The electrode active material composition according to claim 1, wherein the conductive material is at least one conductive carbon selected from the group consisting of acetylene black, carbon black, and ketjen black.

5. The electrode active material composition according to claim 1, wherein the electrode active material is a carbon material having a particle size of 5 to 30 μm.

6. The electrode active material composition according to claim 5, wherein the electrode active material is at least one carbon material selected from the group consisting of activated carbon, carbon nanotube (CNT), graphite, carbon aero gel, polyacrylonitrile (PAN), carbon nanofibers (CNF), activated carbon nanofibers (ACNF), vapor-grown carbon fiber (VGCF), and graphene.

7. The electrode active material composition according to claim 5, wherein the electrode active material is an activated carbon having a specific surface area of 1,500 to 3,000 m²/g.

8. The electrode active material composition according to claim 1, wherein a weight ratio of the electrode active material to the conductive agglomerate is 8.5:0.5 to 1:0.5 to 1.

9. A method for preparing an electrode active material composition, comprising:
agglomerating two or more kinds of conductive materials to prepare a conductive material agglomerate; and
mixing and dispersing the conductive agglomerate and an electrode active material.

10. An electrochemical capacitor using the electrode active material composition according to claim 1.

11. The electrochemical capacitor according to claim 10, wherein the electrode active material is used for any one or both of a cathode and an anode.
